(19) United States
(12) Patent Application Publication
(10) Pub. No.: US 2014/0043286 A1
(43) Pub. Date: Feb. 13, 2014

(54) METHOD FOR IDENTIFYING TOUCH PEN IN ELECTRONIC DEVICE, AND ELECTRONIC DEVICE

(71) Applicant: Samsung Electronics Co. Ltd., Suwon-si (KR)

(72) Inventor: Yong-Seok LEE, Yongin-si (KR)

(21) Appl. No.: 13/924,901

(22) Filed: Jun. 24, 2013

(30) Foreign Application Priority Data
Aug. 8, 2012 (KR) 10-2010-0086726

(51) Int. Cl. G06F 3/0354

(52) U.S. Cl. CPC G06F 3/03545
USPC 345/174; 345/173

(57) ABSTRACT

A device and a method for identifying a touch pen in an electronic device having a touchscreen are provided. The method includes detecting a touch, checking identification information of a touch pen at a touch point using touch information of the touch point, and performing an event according to the touch information in consideration of the identification information of the touch pen.

### PRIORITY

This application claims the benefit under 35 U.S.C. §119 of a Korean patent application filed on Aug. 8, 2012 in the Korean Intellectual Property Office and assigned Serial No. 10-2012-0086726, the entire disclosure of which is hereby incorporated by reference.

### BACKGROUND OF THE INVENTION

1. Field of the Invention

The present invention relates to a device and method for identifying a touch pen in an electronic device having a touchscreen. More particularly, the present invention relates to a method for detecting a touch by a touch pen, checking the identification information of the touch pen, and performing an event based on that information.

2. Description of the Related Art

Portable terminals have become necessary articles of modern persons due to their portability, and have evolved into multimedia devices that provide various services such as voice and video call functions, information input/output functions, and data storage functions.

As described above, as usage of multimedia services using electronic devices increases, the amount of information to be processed by an electronic device, and the amount of information to be displayed thereon, have increased. As a result, there is a growing interest in an electronic device having a touchscreen in which the space thereof is more efficiently used, and in which the size of the display unit thereof is increased.

A touchscreen is an input/output device for performing an input function and for displaying information on one screen. Therefore, an electronic device having a touchscreen performs a corresponding service when a piece of information displayed on the touchscreen is selected through a finger touch by a user.

As described above, as the usage of electronic devices having a touchscreen increases, service providers have developed a variety of technologies for a more accurate touch function. Recently, the usage of a touch pen having higher accuracy than that of a finger touch is increasing. As a result, there is a need for a user interface for utilization of a touch pen.

Therefore, a need exists for a system and method for an improved user interface in an electronic device that allows touch input from a touch pen.

The above information is presented as background information only to assist with an understanding of the present disclosure. No determination has been made, and no assertion is made, as to whether any of the above might be applicable as prior art with regard to the present invention.

### SUMMARY OF THE INVENTION

Aspects of the present invention are to address at least the above-mentioned problems and/or disadvantages and to provide at least the advantages described below. Accordingly, an aspect of the present invention is to provide a device and method for identifying a touch pen in an electronic device having a touchscreen.

Another aspect of the present invention is to provide a device and method for identifying touch pens respectively corresponding to touch information when a multi-touch is detected in an electronic device having a touchscreen.

Another aspect of the present invention is to provide a device and method for providing an event related to the touch information of a touch pen in consideration of the identification information of the touch pen in an electronic device having a touchscreen.

Another aspect of the present invention is to provide a device and method for identifying a touch pen selectively according to the kind of applications in an electronic device.

In accordance with an aspect of the present invention, a method for identifying a touch pen is provided. The method includes detecting a touch, checking identification information of a touch pen at a touch point using touch information of the touch point, and performing an event according to the touch information in consideration of the identification information of the touch pen.

In accordance with another aspect of the present invention, a method for identifying a touch pen is provided. The method includes detecting a touch, checking whether a touch pen is identified at a touch point using touch information, and when the touch pen is not identified, storing identification information of the touch pen.

In accordance with another aspect of the present invention, a method for identifying a touch pen is provided. The method includes detecting a multi-touch, checking identification information of touch pens at respective touch points using touch information of the respective touch points, and performing an event according to the touch information in consideration of the identification information of the respective touch pens.

In accordance with another aspect of the present invention, an electronic device is provided. The device includes at least one processor, a memory, and at least one program stored in the memory and configured to be executed by the at least one processor, wherein the at least one program includes at least one instruction for detecting a touch, checking identification information of a touch pen at a touch point using touch information of the touch point, and performing an event according to the touch information in consideration of the identification information of the touch pen.

In accordance with another aspect of the present invention, an electronic device is provided. The device includes at least one processor, a memory, and at least one program stored in the memory and configured to be executed by the at least one processor, wherein the at least one program includes at least one instruction for detecting a touch, checking whether a touch pen is identified at a touch point using touch information, and when the touch pen is not identified, storing identification information of the touch pen.

In accordance with another aspect of the present invention, an electronic device is provided. The device includes at least one processor, a memory, and at least one program stored in the memory and configured to be executed by the at least one processor, wherein the at least one program includes at least one instruction for detecting a multi-touch, checking identification information of touch pens at respective touch points using touch information of the respective touch points, and performing an event according to the touch information in consideration of the identification information of the respective touch pens.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other objects, features and advantages of certain exemplary embodiments of the present invention will be more apparent from the following description taken in conjunction with the accompanying drawings, in which:

FIG. 1 illustrates a block configuration of an electronic device having a touchscreen according to an exemplary embodiment of the present invention;

FIG. 2 illustrates a block configuration of a processor according to an exemplary embodiment of the present invention;

FIG. 3 illustrates a flowchart for identifying a touch pen in an electronic device having a touchscreen according to a first exemplary embodiment of the present invention;

FIG. 4 illustrates a flowchart for identifying a touch pen in an electronic device having a touchscreen according to a second exemplary embodiment of the present invention;

FIG. 5 illustrates a flowchart for identifying a touch pen in an electronic device having a touchscreen according to a third exemplary embodiment of the present invention;

FIG. 6 illustrates a flowchart for identifying a touch pen in an electronic device having a touchscreen according to a fourth exemplary embodiment of the present invention;

FIGS. 7A-7B illustrate a configuration of a touch screen when an event is performed according to touch information in an electronic device having a touchscreen according to the fourth exemplary embodiment of the present invention;

FIG. 8 illustrates a flowchart for storing identification information and event information of a touch pen in an electronic device having a touchscreen according to an exemplary embodiment of the present invention;

FIG. 9 illustrates a flowchart for updating event information of a touch pen in an electronic device having a touchscreen according to an exemplary embodiment of the present invention; and

FIG. 10 illustrates a configuration of a touch pen according to an exemplary embodiment of the present invention.

Throughout the drawings, it should be noted that like reference numbers are used to depict the same or similar elements, features, and structures.

### DETAILED DESCRIPTION OF THE EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Hereinafter, an exemplary technology for identifying a touch pen in an electronic device having a touchscreen according to the present invention will be described.

In the following description, examples of the electronic device may include a mobile terminal having a touchscreen, a Personal Digital Assistant (PDA), a laptop computer, a smart phone, a netbook, a television, a Mobile Internet Device (MID), an Ultra Mobile Personal Computer (UMPC), a tablet PC, a navigation device, an MP3 player, and the like.

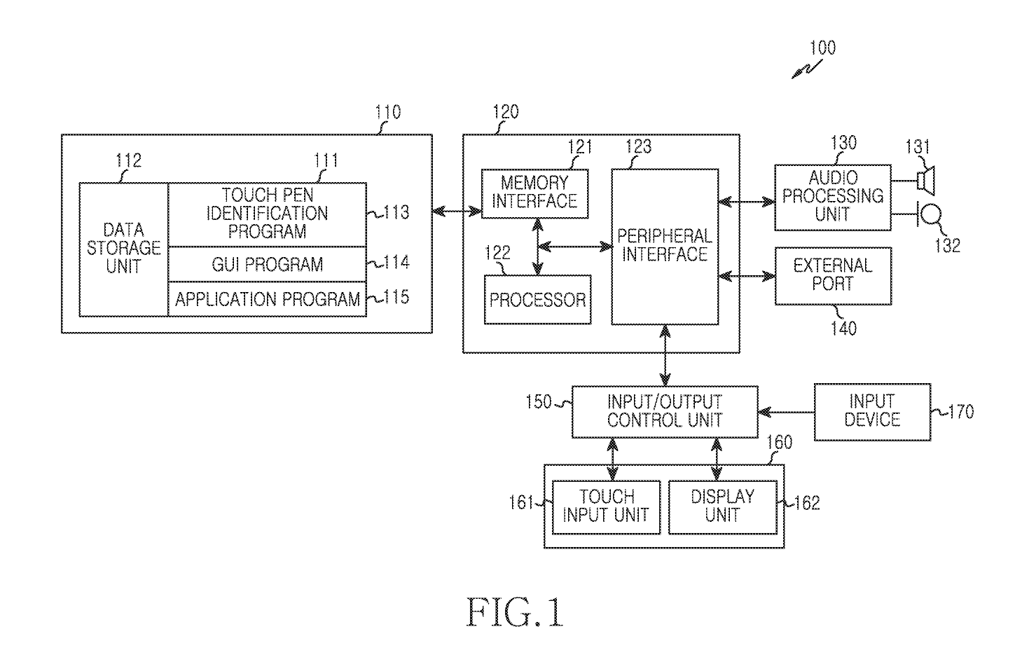

FIG. 1 illustrates a block configuration of an electronic device having a touchscreen according to an exemplary embodiment of the present invention.

Referring to FIG. 1, the electronic device 100 includes a memory 110, a processor unit 120, an audio processing unit 130, an external port 140, an input/output control unit 150, a touchscreen 160, and an input device 170. In this case, the memory 110 and the external port 140 may be provided in plurality.

The respective components will be described below.

The memory 110 may include a program storage unit 111 for storing a program for controlling an operation of the electronic device 100, and a data storage unit 112 for storing data generated during the execution of a program. For example, the data storage unit 112 may store identification information for a touch pen. In addition, the data storage unit 112 may store event information corresponding to the identification information for a touch pen. In this case, the identification information for a touch pen includes at least one of a frequency value, a resistance value and a capacitance value for detection of a touch through the touchscreen according to a touch method. The event information corresponding to the identification information for a touch pen may include event information about events performed by corresponding touch pens or event information about predetermined events.

In another example, the program storage unit 111 includes a touch pen identification program 113, a Graphic User Interface (GUI) program 114 and at least one application program 115. In this case, the programs stored in the program storage unit 111 may be expressed as an instruction set that is a collection of instructions.

The touch pen identification program 113 includes at least one software component for identifying a touch pen at a touch point using touch information detected through the touch input unit 161 of the touchscreen 160. For example, when a multi-touch is detected, the touch pen identification program 113 may identify a first touch pen using touch information at a first touch point and a second touch pen using touch information at a second touch point. In this case, the touch information may include a touch point, a touch gesture (touch, drag and release) and identification information for a touch pen. The identification information for a touch pen may include at least one of a frequency value, a resistance value and a capacitance value for detection of a touch through the touchscreen according to a touch method.

The graphic user interface program 114 includes at least one software component for providing and displaying graphics on the display unit 162.

The application program 115 includes a software component for at least one application program installed in the electronic device 100.

The processor unit 120 may include a memory interface 121, at least one processor 122 and a peripheral interface 123. In this case, the memory interface 121, the at least one processor 122 and the peripheral interface 123 which may be included in the processor unit 120, may be integrated into at least one integrated circuit or may be implemented as separate components.

The memory interface 121 controls access to the memory 100 of components, such as the processor 122 or the peripheral interface 123.

The peripheral interface 123 controls connections between the input/output peripherals of the electronic device 100 and the processor 122 and the memory interface 121.

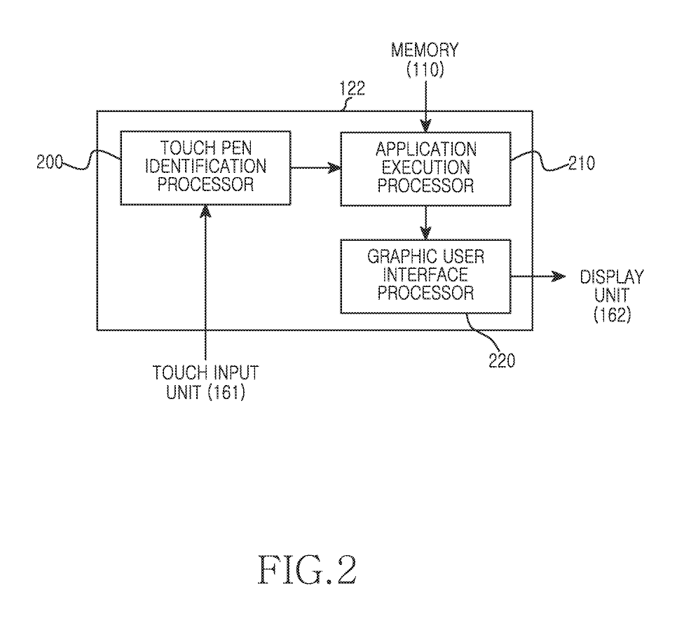

The processor 122 enables the electronic device 100 to provide various multimedia services using at least one software program. For example, the processor 122 may perform control to execute at least one program stored in the memory 100 and provide a service according to a corresponding program. More particularly, the processor 122 may include a touch pen identification processor 200 for executing the touch pen identification program 113, an application program executing processor 210 for executing the application program 115 and a graphic user interface processor 220 for executing the graphic user interface program 114 as shown in FIG. 2.

The audio processing unit 130 provides an audio interface between a user and the electronic device 100 through a speaker 131 and a microphone 132.

The external port 140 may include a connection interface for allowing the electronic device 100 to be connected to an external electronic device directly, or to another electronic device through a network. For example, the external port 140 may include a Universal Serial Bus (USB) port, a High-Definition Multimedia Interface (HDMI) port, or the like.

The input/output control unit 150 provides an interface between an input/output device, such as the touchscreen 160 and the input device 170, and the peripheral interface 123.

The touchscreen 160 is an input/output device for performing the input and output of information and includes a touch input unit 161 and a display unit 162.

The touch input unit 161 provides touch information detected through a touch panel to the processor unit 120 through the input/output control unit 150.

The display unit 162 displays the state information of the electronic device 100, characters input by the user, moving pictures, still pictures, or the like.

The input device 170 provides input data generated by the selection of the user to the processor unit 120 through the input/output control unit 150. For example, the input device 170 may be configured to include only control buttons for control of the electronic device 100. In another example, the input device 170 may be configured by a keypad for receiving input data from the user.

Although not shown in drawings, the electronic device 100 may further include a communication system for executing communication functions for voice communication and data communication. In this case, the communication system may be classified into a plurality of communication sub-modules which support different communication networks. For example, the communication networks may include, but not limited to, a Global System for Mobile communication (GSM) network, an Enhanced Data GSM Environment (EDGE) network, a Code Division Multiple Access (CDMA) network, a W-Code Division Multiple Access (W-CDMA) network, a Long Term Evolution (LTE) network, an Orthogonal Frequency Division Multiple Access (OFDMA) network, a wireless LAN, a Bluetooth network and a Near Field Communication (NFC) network and the like.

In addition, the electronic device 100 may further include an identification information management program for generating the identification information of a corresponding touch pen when a touch pen cannot be identified at a touch point through the touch pen identification program 113. In this case, the touch pen identification program may match event information about an event to be performed through a touch input by a corresponding touch pen with the identification information of the touch pen. In this case, the event information corresponding to the identification information of the touch pen may include at least one piece of event information selected from among information about an event performed by the corresponding touch pen, information about an event preset by a system and information about an event set by a user.

In addition, when an event to be performed by the touch pen having identification information is changed, the identification information management program may update event information corresponding to the identification information of the touch pen which is stored in the data storage unit 112.

FIG. 2 illustrates a block configuration of a processor according to an exemplary embodiment of the present invention.

Referring to FIG. 2, the processor 122 includes a touch pen identification processor 200, an application execution processor 210 and a graphic user interface processor 220.

The touch pen identification processor 200 may include instructions to execute the touch pen identification program 113 of the program storage unit 111 and to identify a touch pen at a touch point using touch information detected through the touch input unit 161 of the touch screen 160. For example, when a multi-touch is detected, the touch pen identification processor 200 may identify a first touch pen using identification information at a first touch point and a second touch pen using identification information at a second touch point. In this case, touch information includes a touch point, a touch gesture (touch, drag and release) and the identification information of a touch pen. The identification information of a touch pen includes at least one of a frequency value, a resistance value and a capacitance value for detection of a touch through a touchscreen according to a touch method.

The application execution processor 210 executes the application program 115 of the program storage unit 111 to identify a touch pen selectively according to the types of applications. For example, when a pen identification service is used in applications, the application execution processor 210 may include an instruction for performing an event in consideration of the identification information and touch information of a touch pen which are provided by the touch pen identification processor 200.

The graphic user interface processor 220 executes the graphic user interface program 115 of the program storage unit 111 to provide and display graphics on the display unit 162. For example, the graphic user interface processor 220 may include an instruction for displaying an event on the display unit 162 in consideration of the touch information and identification information of a touch pen in cooperation with the application executing processor 210.

Although not shown in drawings, the electronic device 100 may further include an identification information management processor which may include an instruction for generating the identification information of a corresponding touch pen when the touch pen is not identified at a touch point through the touch pen identification processor 200. In this case, the identification information management processor matches event information about an event to be performed through the touch input of the corresponding touch pen with the identification information of the touch pen. The event information corresponding to the identification information of the touch pen may include at least one piece of event information selected from among information about an event performed by the corresponding touch pen, information about an event preset by a system, and information about an event set by the user.

In addition, the identification information management processor may update event information corresponding to the identification information of a touch pen which is stored in the data storage unit 112 when an event to be performed by a touch pen having identification information is changed.

In the above-described exemplary embodiments, the electronic device 100 may include a touch pen identification program 113 and a graphic user interface program 115 for identification of touch pens at respective touch points using touch information when a multi-touch is detected. Therefore, the electronic device 100 may control to identify touch pens at respective touch points using touch information when a multi-touch is detected by executing programs included in the program storage unit 111 in the processor 122 configured as illustrated in FIG. 2.

In other exemplary embodiments, the electronic device 100 may control to identify touch pens at respective touch points using touch information when a multi-touch is detected using the processor 122 including information about the touch pen identification program 113 and the graphic user interface program 114. More specifically, the processor 122 configured as illustrated in FIG. 2 may include information about the touch pen identification program 113 and the graphic user interface program 114.

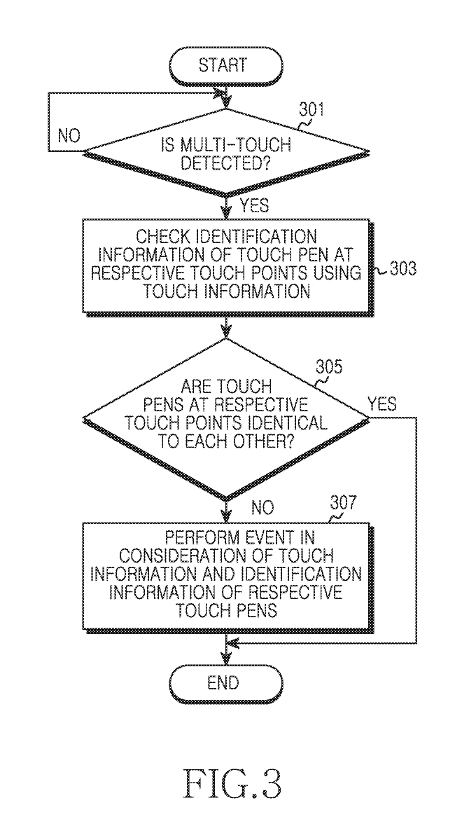

FIG. 3 illustrates a flowchart for identifying a touch pen in an electronic device having a touchscreen according to a first exemplary embodiment of the present invention.

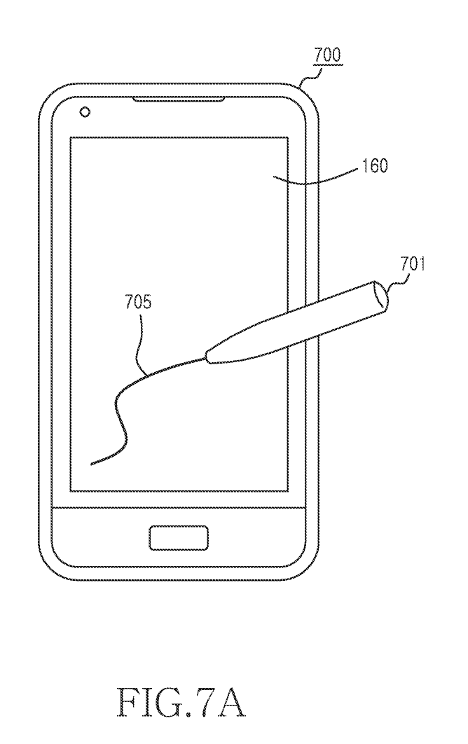

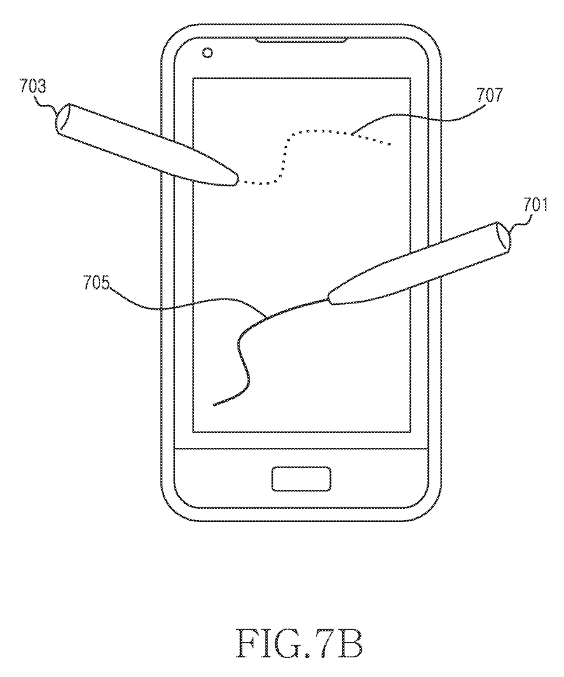

Referring to FIG. 3, in step 301, the electronic device checks whether a multi-touch is detected through the touch input unit of a touchscreen. For example, the electronic device checks whether the multi-touch is detected by a first touch pen 701 and a second touch pen 703 as illustrated in FIG. 7B.

When the multi-touch is detected, in step 303, the electronic device checks the identification information of touch pens at respective touch points using touch information. For example, the electronic device may identify the first touch pen using the identification information of the first touch point and the second touch pen using the identification information of the second touch point, which are detected through the touch input unit of the touchscreen. The touch information may include a touch point, a touch gesture (touch, drag and release) and the identification information of a touch pen. The identification information of a touch pen may include at least one of a frequency value, a resistance value and a capacitance value for detection of a touch through a touchscreen according to a touch method.

After checking the identification information of touch pens at the respective touch points using the touch information, in step 305, the electronic device may check whether the touch pens at the respective touch points are identical to each other. If the touch pens at the respective touch points are identical to each other, the electronic device may perceive that the multi-touch detected in step 301 is a multi-touch made by an identical touch pen. As a result, the electronic device may end the algorithm. In this case, the electronic device may perform an event in consideration of the multi-touch.

On the other hand, when the touch pens at the respective points are different from each other, in step 307, the electronic device may perform an event in consideration of the touch information of the respective touch pens and the identification information of the respective touch pens. For example, the electronic device may check event information corresponding to the identification information of the respective touch pens. Thereafter, the electronic device may perform an event in consideration of the touch information and event information of the respective touch pens. In exemplary embodiments, the event information corresponding to the identification information of the touch pens includes at least one piece event information selected from among information about an event performed by the corresponding touch pen, information about an event preset by a system, and information about an event set by the user.

Thereafter, the electronic device ends the algorithm.

As described above, when a multi-touch is detected, the electronic device may identify touch pens at respective touch points using touch information. In such case, i.e., when a multi-touch is detected, the electronic device may be configured by respective means for identifying touch pens at respective touch points using touch information. In addition, when a multi-touch is detected, the electronic device may be configured by a single means into which respective means for identifying touch pens at respective touch points using touch information are integrated.

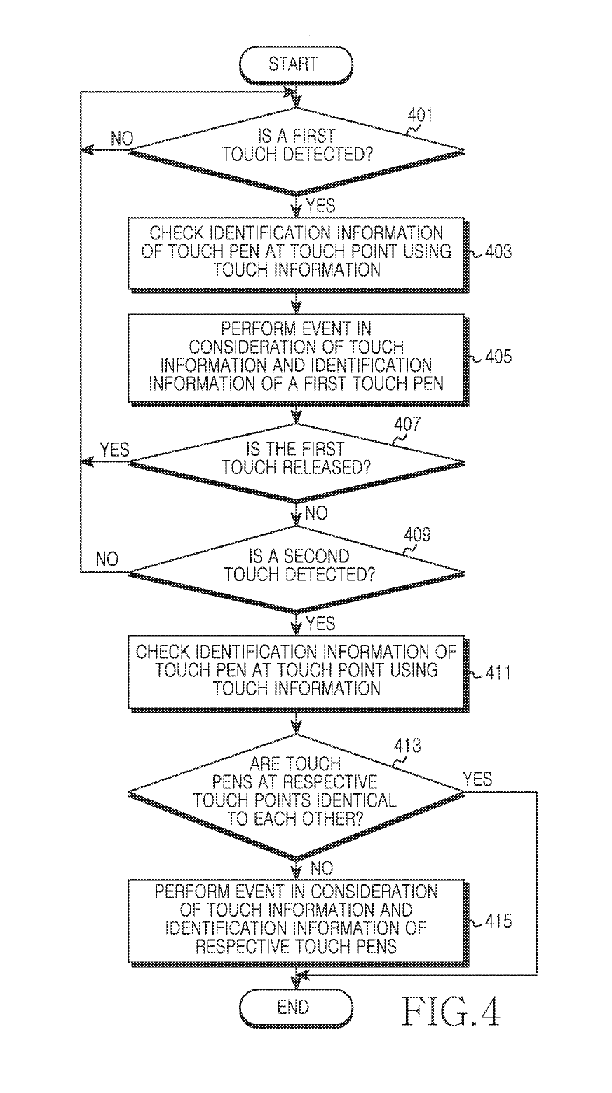

FIG. 4 illustrates a flowchart for identifying a touch pen in an electronic device having a touchscreen according to a second exemplary embodiment of the present invention.

Referring to FIG. 4, in step 401, the electronic device checks whether a first touch is detected. For example, the electronic device may check whether the touch is detected by a first touch pen 701 through the touch input unit of the touchscreen as illustrated in FIG. 7A.

When the first touch is detected, in step 403, the electronic device checks the identification information of a touch pen at a touch point using touch information. For example, the electronic device may identify the first touch pen using the identification information of a first touch point through the touch input unit of the touchscreen. In this case, the touch information may include a touch point, a touch gesture (touch, drag and release) and the identification information of a touch pen. The identification information of a touch pen may include at least one of a frequency value, a resistance value and a capacitance value for detection of a touch through a touchscreen according to a touch method.

After checking the identification information of the touch pen at the touch point using the touch information, in step 405, the electronic device performs an event in consideration of the touch information of the first touch pen and the identification information of the first touch pen. For example, the electronic device may check event information corresponding to the identification information of the first touch pen. Then, the electronic device performs an event in consideration of the touch information and event information of the first touch pen. In this case, the event information corresponding to the identification information of the first touch pen may be at least one piece of event information selected from among information about an event performed by the first touch pen, information about an event preset by a system, and information about an event set by the user. More particularly, when a drawing has been made using a pen, the event information may include the color and thickness of the pen, and the like. Alternatively, for example, when the “Go” game is played using a pen, the event information may include a black stone and a white stone.

After performing the event in consideration of the touch information of the first touch pen and the identification information of the first touch pen, in step 407, the electronic device checks whether the first touch has been released. If the first touch has been released, the electronic device returns to step 401 to check whether the first touch is detected.

On the other hand, if the first touch has not been released, the electronic device perceives that the first touch is kept. Therefore, the electronic device proceeds to step 409. In step 409, the electronic device checks whether a second touch is detected. For example, the electronic device checks whether touch is detected by a second pen 703 through the touch input unit of the touchscreen as illustrated in FIG. 7B.

When the second touch is detected, in step 411, the electronic device checks the identification information of a touch pen at a touch point using touch information. For example, the electronic device identifies a second touch pen using the identification information of the second touch point through the touch input unit of the touchscreen. In this case, the touch information includes a touch point, a touch gesture (touch, drag and release) and the identification information of a touch pen. The identification information of a touch pen includes at least one of a frequency value, a resistance value and a capacitance value for detection of a touch through a touchscreen according to a touch method.

After checking the identification information of touch pens at the respective touch points using the touch information, in step 413, the electronic device checks whether the touch pens at the respective touch points are identical to each other. If the touch pens at the respective touch points are identical to each other, the electronic device perceives that the multi-touch is a multi-touch made by an identical touch pen. As a result, the electronic device ends the algorithm. In this case, the electronic device may perform an event in consideration of the multi-touch.

On the other hand, when the touch pens at the respective points are different from each other, in step 415, the electronic device may perform an event in consideration of the touch information of the respective touch pens and the identification information of the respective touch pens. For example, the electronic device may check event information corresponding to the identification information of the respective touch pens. Thereafter, the electronic device may perform an event in consideration of the touch information and event information of the respective touch pens. In this case, the event information corresponding to identification information of the touch pens may include at least one piece of event information selected from among information about an event performed by the corresponding touch pen, information about an event preset by a system, and information about an event set by the user.

Thereafter, the electronic device ends the algorithm.

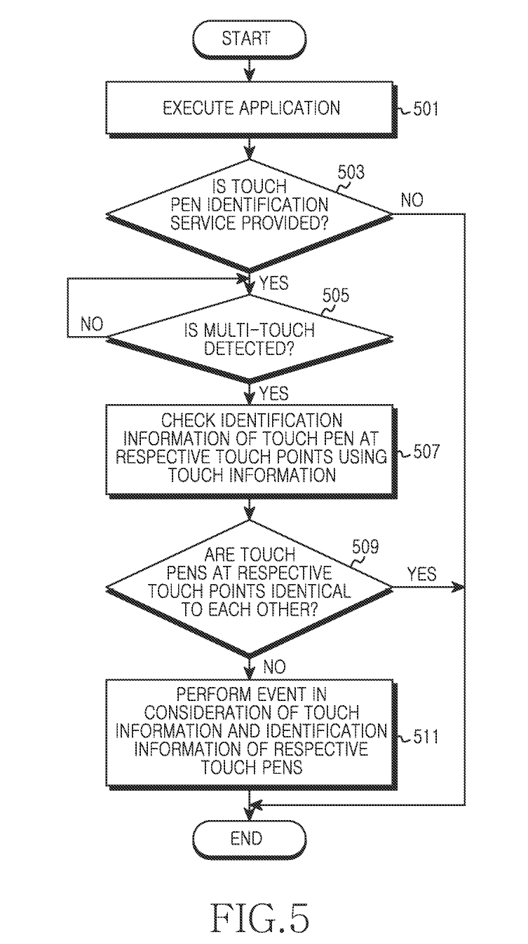

FIG. 5 illustrates a flowchart for identifying a touch pen in an electronic device having a touchscreen according to a third exemplary embodiment of the present invention.

Referring to FIG. 5, in step 501, the electronic device executes an application. For example, the electronic device executes an application selected by operation of a user.

After executing the application, in step 503, the electronic device checks whether a touch pen identification service is provided. If the touch pen identification service is not provided, the electronic device ends the algorithm.

On the other hand, when the touch pen identification service is provided, in step 505, the electronic device may check whether a multi-touch is detected through the touch input unit of the touchscreen. For example, the electronic device may check whether the multi-touch is detected by a first touch pen 701 and a second touch pen 703 as illustrated in FIG. 7B.

When the multi-touch is detected, in step 507, the electronic device may check the identification information of touch pens at respective touch points using touch information. For example, the electronic device may identify the first touch pen using the identification information of the first touch point and the second touch pen using the identification information of the second touch point, where the first and second touch points are detected through the touch input unit of the touchscreen. In this case, the touch information may include a touch point, a touch gesture (touch, drag and release) and the identification information of a touch pen. The identification information of a touch pen may include at least one of a frequency value, a resistance value and a capacitance value for the detection of a touch through a touchscreen according to a touch method according to an exemplary embodiment herein.

After checking the identification information of touch pens at the respective touch points using the touch information, in step 509, the electronic device may check whether the touch pens at the respective touch points are identical to each other. If the touch pens at the respective touch points are identical to each other, the electronic device may perceive that the multi-touch detected in step 505 is a multi-touch made by an identical touch pen. As a result, the electronic device ends the algorithm. In this case, the electronic device may perform an event in consideration of the multi-touch.

On the other hand, when the touch pens at the respective points are different from each other, in step 511, the electronic device may perform an event in consideration of the touch information of the respective touch pens and the identification information of the respective touch pens. For example, the electronic device may check event information corresponding to the identification information of the respective touch pens. Thereafter, the electronic device may perform an event in consideration of the touch information and event information of the respective touch pens. In this case, the event information corresponding to the identification information of the touch pens may include at least one piece of event information selected from among information about an event performed by the corresponding touch pen, information about an event preset by a system, and information about an event set by the user. More specifically, when a drawing has been made using a pen, the event information may include the color and thickness of the pen, and the like. Alternatively, for example, when the “Go” game is played using a pen, the event information may include a black stone and a white stone.

Thereafter, the electronic device ends the algorithm.

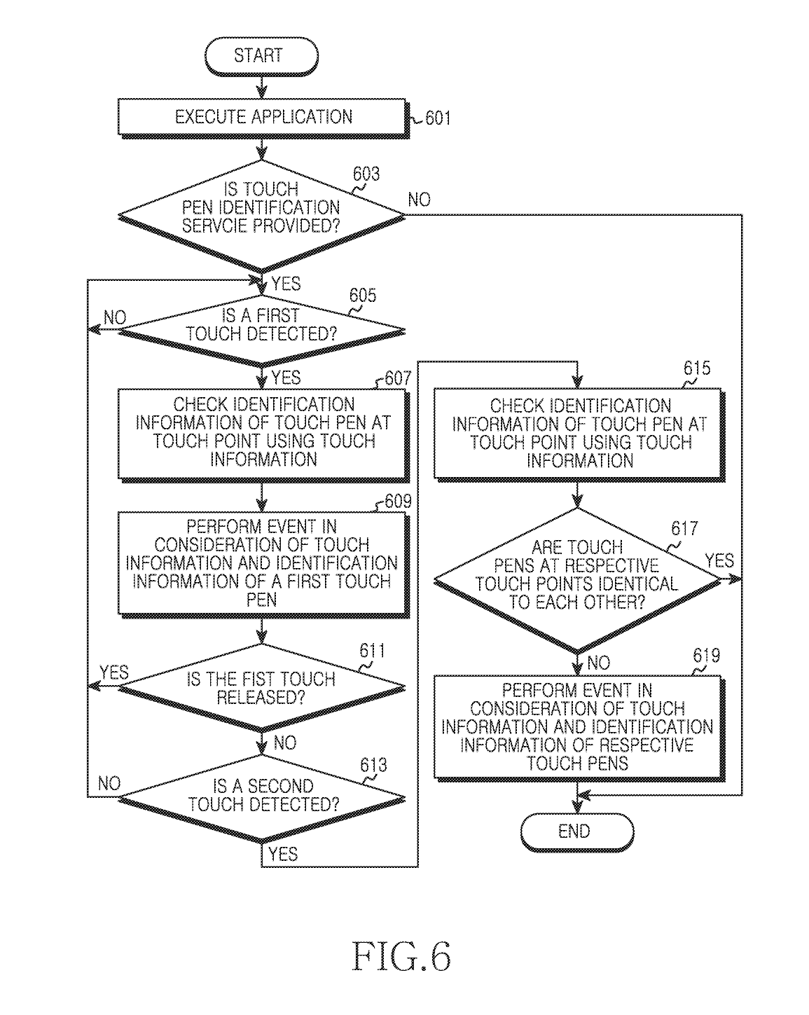

FIG. 6 illustrates a flowchart for identifying a touch pen in an electronic device having a touchscreen according to a fourth exemplary embodiment of the present invention.

Referring to FIG. 6, in step 601, the electronic device executes an application. For example, the electronic device executes an application selected by operation of a user.

After executing the application, in step 603, the electronic device checks whether to provide a touch pen identification service. If the touch pen identification service is not provided, the electronic device ends the algorithm.

On the other hand, when the touch pen identification service is provided, in step 605, the electronic device checks whether a first touch is detected. For example, the electronic device checks whether the touch is detected by a first touch pen 701 through the touch input unit of the touchscreen as illustrated in FIG. 7A.

When the first touch is detected, in step 607, the electronic device checks the identification information of a touch pen at a touch point using touch information. For example, the electronic device may identify the first touch pen using the identification information of a first touch point through the touch input unit of the touchscreen. The touch information may include a touch point, a touch gesture (touch, drag and release) and the identification information of a touch pen. The identification information of a touch pen may include at least one of a frequency value, a resistance value and a capacitance value for detection of a touch through a touchscreen according to a touch method of an exemplary embodiment.

After checking the identification information of the touch pen at the touch point using the touch information, in step 609, the electronic device performs an event in consideration of the touch information of the first touch pen and the identification information of the first touch pen. For example, the electronic device may check event information corresponding to the identification information of the first touch pen. Then, the electronic device may perform an event in consideration of the touch information and event information of the first touch pen. In this case, the event information corresponding to the identification information of the first touch pen is at least one piece of event information selected from among information about an event performed by the first touch pen, information about an event preset by a system, and information about an event set by the user. More particularly, when a drawing has been made using a pen, the event information may include the color and thickness of the pen, and the like. Alternatively, for example, when the “Go” game is played using a pen, the event information may include a black stone and a white stone.

After performing the event in consideration of the touch information of the first touch pen and the identification information of the first touch pen, in step 611, the electronic device may check whether the first touch has been released. If the first touch has been released, the electronic device may return to step 605 to check whether the first touch is detected.

On the other hand, if the first touch has not been released, the electronic device perceives that the first touch is kept. Therefore, the electronic device proceeds to step 613. In step 613, the electronic device checks whether a second touch is detected. For example, the electronic device may check whether a touch is detected by a second pen 703 through the touch input unit of the touchscreen as illustrated in FIG. 7B.

When the second touch is detected, in step 615, the electronic device checks the identification information of a touch pen at a touch point using touch information. For example, the electronic device may identify a second touch pen using the identification information of the second touch point through the touch input unit of the touchscreen. The touch information may include a touch point, a touch gesture (touch, drag and release) and the identification information of a touch pen. The identification information of a touch pen may include at least one selected from among a frequency value, a resistance value and a capacitance value for detection of a touch through a touchscreen according to a touch method.

After checking the identification information of touch pens at the respective touch points using the touch information, in step 617, the electronic device checks whether the touch pens at the respective touch points are identical to each other. If the touch pens at the respective touch points are identical to each other, the electronic device perceives that the multi-touch is a multi-touch made by an identical touch pen. As a result, the electronic device ends the algorithm. In this case, the electronic device may perform an event in consideration of the multi-touch.

On the other hand, when the touch pens at the respective points are different from each other, in step 617, the electronic device, in step 619, performs an event in consideration of the touch information of the respective touch pens and the identification information of the respective touch pens. For example, the electronic device may check event information corresponding to the identification information of the respective touch pens. Thereafter, the electronic device may perform an event in consideration of the touch information and event information of the respective touch pens. The event information corresponding to the identification information of the touch pens may include at least one piece of event information selected from among event information about an event performed by the corresponding touch pen, event information about an event preset by a system, and event information about an event set by the user.

Thereafter, the electronic device ends the algorithm.

FIGS. 7A-7B illustrate a configuration of a screen in which an event is performed according to touch information in an electronic device having a touchscreen according to a fourth exemplary embodiment of the present invention.

Referring to FIG. 7A, the electronic device 700 displays a solid line 705 on the display unit 160 in consideration of the touch information of the first touch pen 701.

Referring to FIG. 7B, the electronic device 700 may display a dotted line 707 on the display unit 160 in consideration of the touch information of the second touch pen 703 as illustrated in FIG. 7B.

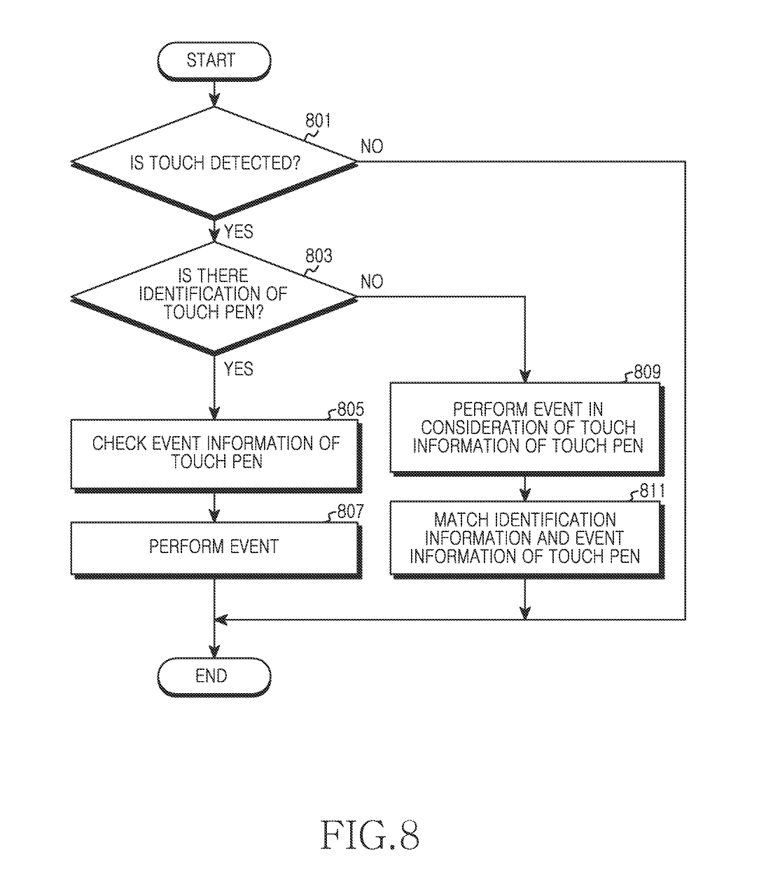

FIG. 8 illustrates a flowchart for storing identification information and event information of a touch pen in an electronic device having a touchscreen according to an exemplary embodiment of the present invention.

Referring to FIG. 8, in step 801, the electronic device checks whether a touch is detected through the touch input unit of a touchscreen. For example, the electronic device may check whether the touch is detected by a first touch pen 701 as illustrated in FIG. 7A. Likewise, the electronic device may check whether the touch is detected by a second touch pen 703 as illustrated in FIG. 7B.

When the touch is detected, in step 803, the electronic device checks whether there is the identification information of the touch pen according to touch information. For example, the electronic device identifies a first touch pen using the identification information at the first touch point detected through the touch input unit of the touchscreen. Thereafter, the electronic device checks whether the identification information related to the first touch pen is stored. In this case, the touch information includes a touch point, a touch gesture (touch, drag and release) and the identification information of a touch pen. The identification information of a touch pen includes at least one of a frequency value, a resistance value and a capacitance value for detection of a touch through a touchscreen according to a touch method.

When there is the identification information of the touch pen, in step 805, the electronic device checks event information corresponding to the touch pen. In exemplary embodiments, the event information may include at least one piece of event information selected from among information about an event performed by the first touch pen, information about an event preset by a system and information about an event set by the user. More specifically, when a drawing has been made using a pen, the event information includes the color and thickness of the pen, and the like. Alternatively, when the Go game is played using a pen, the event information includes a black stone and a white stone.

After checking the identification information of the touch pen, in step 807, the electronic device performs an event in consideration of the event information of the touch pen which has been checked in step 805.

On the other hand, when the identification information of the touch pen does not exist, the electronic device perceives that an event has not been performed by the touch pen detected in step 801. As a result, in step 809, the electronic device performs an event in consideration of the touch information of the touch pen. For example, the electronic device displays a solid line 705 on the display unit 160 in consideration of the touch information of the first touch pen 701 as illustrated in FIG. 7A. In another example, the electronic device may display a dotted line 707 on the display unit 160 in consideration of the touch information of the second touch pen 703 as illustrated in FIG. 7B.

After performing the event in consideration of the touch information of the touch pen, in step 811, the electronic device matches the identification information of the touch pen with event information about the event performed by the touch pen. For example, when displaying the solid line 705 on the display unit 160 by the first touch pen 701 as illustrated in FIG. 7B, the electronic device matches the identification information of the first touch pen 701 with the event information about the event for displaying the solid line. In another example, when displaying the dotted line 707 on the display unit 160 by the second touch pen 703 as illustrated in FIG. 7B, the electronic device may match the identification information of the second touch pen 703 with the event information about the event for displaying the dotted line.

Thereafter, the electronic device ends the algorithm.

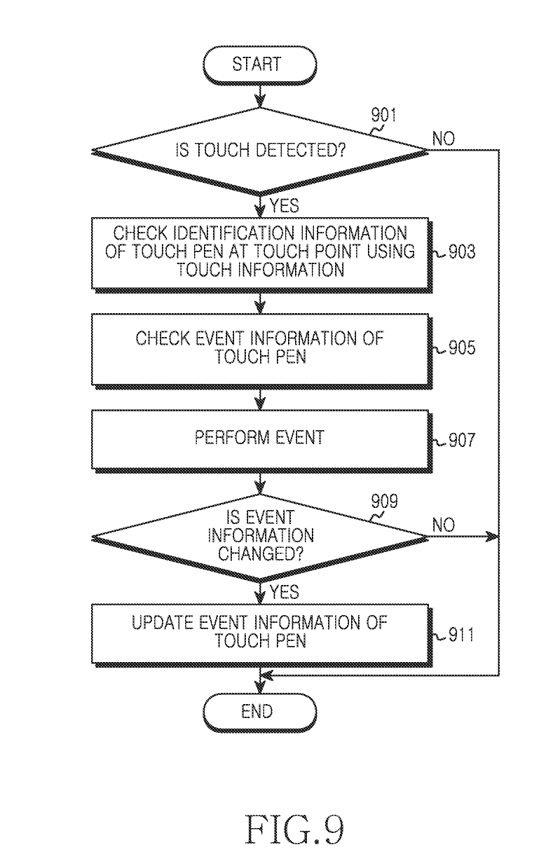

FIG. 9 illustrates a flowchart for updating event information of a touch pen in an electronic device having a touchscreen according to an exemplary embodiment of the present invention.

Referring to FIG. 9, in step 901, the electronic device checks whether a touch is detected through the touch input unit of a touchscreen. For example, the electronic device may check whether the touch is detected by a first touch pen 701 as illustrated in FIG. 7A.

When the touch is detected, in step 903, the electronic device checks the identification information of the touch pen at a touch point using touch information. For example, the touch pen is identified using the identification information at the touch point through the touch input unit of the touchscreen. In this case, the touch information includes a touch point, a touch gesture (touch, drag and release) and the identification information of a touch pen. The identification information of a touch pen includes at least one of a frequency value, a resistance value and a capacitance value for detection of a touch through a touchscreen according to a touch method.

After checking the identification information of the touch pen, in step 905, the electronic device checks event information corresponding to the identification information of the touch pen. In this case, the event information corresponding to the identification information of the touch pen may include at least one piece of event information selected from among information about an event performed by the touch pen, information about an event preset by a system, and information about an event set by the user.

After checking the event information of the touch pen, in step 907, the electronic device performs an event in consideration of the event information checked in step 905. For example, the electronic device displays a solid line on the display unit 160 in consideration of the event information and first touch information of the first touch pen. In this case, the electronic device may perform another event according to the touch information of the touch pen along with the event checked in step 905.

After performing the event in consideration of the event information, in step 909, the electronic device checks whether the event information of the touch pen about the event performed in step 907 is different from the event information checked in step 905. If the event information of the touch pen is not changed, the electronic device ends the algorithm.

On the other hand, when the event information of the touch pen is changed, in step 911, the electronic device updates the event information of the touch pen. For example, after the event for displaying the solid line on the display unit 160 has been performed by the first touch pen 701, when the event for displaying the dotted line on the display unit 160 is performed by the first touch pen 701, the electronic device updates the event information of the first touch pen to represent the event information about the event for displaying the dotted line.

Thereafter, the electronic device ends the algorithm.

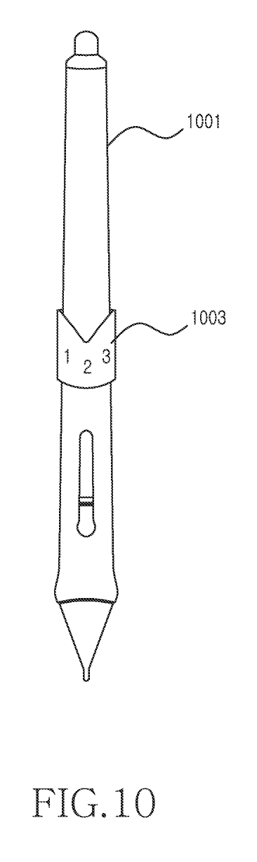

FIG. 10 illustrates a configuration of a touch pen according to an exemplary embodiment of the present invention.

Referring to FIG. 10, the touch pen 1001 may include a dial and button 1003 for changing at least one of a frequency value, a resistance value and a capacitance value for detection of a touch through a touchscreen.

In the above described exemplary embodiments, the electronic device performs an event in consideration of information about a multi-touch by a first touch pen and a second touch pen. In another exemplary embodiment, the electronic device may perform an event in consideration of the touch information about touches made by n touch pens. In still another exemplary embodiment, the electronic device may perform an event in consideration of information about a touch made by any one touch pen.

As described above, the present invention provides advantages in that when a multi-touch is detected in an electronic device having a touchscreen, the electronic device checks the identification information corresponding to touch information, and, therefore, provides an event corresponding to the touch information in consideration of the identification information of the touch pen.

Embodiments of the present disclosure according to the claims and description in the specification can be realized in the form of hardware, software or a combination of hardware and software.

Such software may be stored in a computer readable storage medium. The computer readable storage medium stores one or more programs (software modules), the one or more programs comprising instructions, which when executed by one or more processors in an electronic device, cause the electronic device to perform a method of the present disclosure.

Such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape or the like. It will be appreciated that the storage devices and storage media are embodiments of machine-readable storage that are suitable for storing a program or programs comprising instructions that, when executed, implement embodiments of the present disclosure. Embodiments provide a program comprising code for implementing apparatus or a method as claimed in any one of the claims of this specification and a machine-readable storage storing such a program. Still further, such programs can be conveyed electronically via any medium such as a communication signal carried over a wired or wireless connection and embodiments suitably encompass the same.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method in an electronic device, the method comprising:
detecting a touch;
checking identification information of a touch pen at a touch point using touch information of the touch point; and
performing an event according to the touch information in consideration of the identification information of the touch pen.

2. The method of claim 1, wherein the touch information includes the touch point, a touch gesture including touch, drag and release, and the identification information of the touch pen, and
the identification information of the touch pen includes at least one of a frequency value, a resistance value and a capacitance value for detection of a touch through a touchscreen.

3. The method of claim 1, further comprising:
executing an application; and
checking whether to identify the touch pen by the application,
wherein, if the touch pen is identified by the application, a return to the detecting a touch is performed.

4. The method of claim 1, wherein the performing of the event includes:
checking event information corresponding to the touch pen; and
performing an event according to a corresponding touch pen in consideration of the touch information.

5. The method of claim 1, further comprising:
checking whether the event information corresponding to the touch pen is changed; and
if the event information is changed, updating the event information corresponding to the touch pen.

6. The method of claim 5, wherein the event information corresponding to the touch pen includes at least one piece of event information selected from among information about an event performed by the touch pen, information about an event preset by a system, and information about an event set by a user.

7. A method in an electronic device, the method comprising:
detecting a touch;
checking whether a touch pen is identified at a touch point using touch information; and
if the touch pen is not identified, storing identification information of the touch pen.

8. The method of claim 7, further comprising performing an event according to the touch information in consideration of the identification information of the touch pen.

9. The method of claim 8, further comprising matching the identification information of the touch pen with event information about the event performed according to the touch information.

10. The method of claim 7, further comprising:
checking event information corresponding to the touch pen if the touch pen is not identified; and
performing an event according to the touch pen in consideration of the touch information.

11. The method of claim 10, further comprising:
checking whether the event information corresponding to the touch pen is changed; and
if the event information is changed, updating the event information according to the touch pen.

12. A method in an electronic device, the method comprising:
detecting a multi-touch;
checking identification information of touch pens at respective touch points using touch information of the respective touch points; and
performing an event according to the touch information in consideration of the identification information of the respective touch pens.

13. The method of claim 12, further comprising:
executing an application; and
checking whether to identify the touch pen by the application,
wherein, if the touch pen is identified by the application, a return to the detecting a multi-touch is performed.

14. The method of claim 12, wherein the performing of the event includes:
checking event information corresponding to the respective touch pens; and
performing an event according to a corresponding touch pen in consideration of the touch information.

15. The method of claim 12, wherein the performing of the event includes:
checking whether the touch pens at the touch points are identical to each other by comparing the identification information of the touch pens at the respective touch points; and
performing an event according to the touch information in consideration of the identification information of the respective touch pens if the touch pens of the respective touch points are not identical to each other.

16. The method of claim 15, further comprising performing a multi-touch event in consideration of the touch information related to the multi-touch.

17. An electronic device, the method comprising:
at least one processor;
a memory; and
at least one program stored in the memory and configured to be executed by the at least one processor,
wherein the at least one program includes at least one instruction for:
detecting a touch;
checking identification information of a touch pen at a touch point using touch information of the touch point; and
performing an event according to the touch information in consideration of the identification information of the touch pen.

18. The electronic device of claim 17, wherein the touch information includes the touch point, a touch gesture including touch, drag and release, and the identification information of the touch pen, and
the identification information of the touch pen includes at least one of a frequency value, a resistance value and a capacitance value for detection of a touch through a touchscreen.

19. The electronic device of claim 17, wherein the at least one program further includes an instruction for:
executing an application; and
checking whether to identify the touch pen by the application,
wherein the touch is detected if the touch pen is identified by the application.

20. The electronic device of claim 17, wherein the instruction for performing an event comprises:
checking event information corresponding to the touch pen; and
performing an event according to a corresponding touch pen in consideration of the touch information.

21. The electronic device of claim 17, wherein the at least one program further comprises an instruction for:
checking whether the event information corresponding to the touch pen is changed; and
if the event information is changed, updating the event information corresponding to the touch pen.

22. The electronic device of claim 21, wherein the event information corresponding to the touch pen includes at least one piece of event information selected from among event information about an event performed by the touch pen, event information about an event preset by a system, and event information about an event set by a user.

23. An electronic device, the method comprising:
at least one processor;
a memory; and
at least one program stored in the memory and configured to be executed by the at least one processor,
wherein the at least one program includes at least one instruction for:
detecting a touch;
checking whether a touch pen is identified at a touch point using touch information; and
if the touch pen is not identified, storing identification information of the touch pen.

24. The electronic device of claim 23, wherein the at least one program further includes an instruction for performing an event according to the touch information in consideration of the identification information of the touch pen.

25. The electronic device of claim 24, wherein the at least one program further includes an instruction for matching the identification information of the touch pen with event information about the event performed according to the touch information.

26. The electronic device of claim 23, wherein the at least one program further includes an instruction for:
checking event information corresponding to the touch pen if the touch pen is not identified; and
performing an event according to the touch pen in consideration of the touch information.

27. The electronic device of claim 26, wherein the at least one program further includes an instruction for:
checking whether the event information corresponding to the touch pen is changed; and
if the event information is changed, updating the event information according to the touch pen.

28. An electronic device, the device comprising:
at least one processor;
a memory; and
at least one program stored in the memory and configured to be executed by the at least one processor,
wherein the at least one program includes at least one instruction for:
detecting a multi-touch;
checking identification information of touch pens at respective touch points using touch information of the respective touch points; and
performing an event according to the touch information in consideration of the identification information of the respective touch pens.

29. The electronic device of claim 28, wherein the at least one program further includes an instruction for:
executing an application; and
checking whether to identify the touch pen by the application,
wherein the multi-touch is detected if the touch pen is identified by the application.

30. The electronic device of claim 28, wherein the instruction for performing an event comprises:
checking event information corresponding to the respective touch pens; and
performing an event according to a corresponding touch pen in consideration of the touch information.

31. The electronic device of claim 28, wherein the instruction for performing an event comprises:
checking whether the touch pens at the touch points are identical to each other by comparing the identification information of the touch pens at the respective touch points; and
performing an event according to the touch information in consideration of the identification information of the respective touch pens if the touch pens of the respective touch points are not identical to each other.

32. The electronic device of claim 31, wherein the at least one program further includes an instruction for performing a multi-touch event in consideration of the touch information related to the multi-touch.
